(19) United States
(12) Patent Application Publication
(10) Pub. No.: US 2006/0257618 A1
(43) Pub. Date: Nov. 16, 2006

(54) Procedure to obtain flocked surfaces with two or more colours in the hair/flocking material, and the final product

(76) Inventor: Rafael Pascual Bernabeu, Muro de Alcoy (ES)

Correspondence Address: MICHAELSON & ASSOCIATES, P.O. BOX 8489, RED BANK, NJ, 07701, US

(21) Appl. No.: 11/178,868

(22) Filed: Jul. 11, 2005

(30) Foreign Application Priority Data
May 10, 2005 (ES) 200501120

(51) Int. Cl. B32B 33/00; B05D 1/14; B05D 1/16

(52) U.S. Cl. 428/90; 427/463; 427/464; 427/202; 427/206

(57) ABSTRACT

A procedure is described to obtain flocked surfaces with one, two or more colours in the hair/flocking material, where the surfaces of the base material have a layer of adhesive material and flocking material applied and where the flocking material is fixed to the adhesive by drying and thermo-fixing. The process includes the stages of applying a printing paste which includes the desired colours, these pastes having a subliminal nature with the application of heat, to apply the adhesive layer to the previously printed colours, to flock the desired surface with white or light coloured hair/flocking material, to carry out the drying and thermo-fixing operation and to bring about the colour sublimation in an upward direction starting from the fabric surface towards the upper part of the flocking with the aim of bringing about the colouring of the latter.

### OBJECT OF THE INVENTION

The present invention refers to a procedure to obtain flocked surfaces with two or more colours in the hair/flocking material, and the final product, which contributes several advantages and novelty characteristics in comparison to the methods currently known and used for the same purposes in the present state of the art.

More specifically, the invention proposes the development of a procedure for the obtaining of surface that has been flocked with white nylon or polyester hair/flocking material, which has been previously cut, in which two or more colours can be seen in the hair/flocking material by virtue of the application of a process to the entirety which includes printing, flocking, thermo-fixing and sublimation.

The field of application of the invention is to be found, obviously, amongst the industrial sector that is involved in the manufacture of fabrics for the upholstering of furniture, the insides of cars, carpets, footwear, rugs and surface coverings, and other applications.

### BACKGROUND OF THE INVENTION

At the present time a multitude of flocked fabrics are known by experts in the field with the present state of the art for a wide variety of flocked surfaces, and whose dyed surface has normally been obtained, either by dyeing the flocking material prior to being flocked, or equally by the dyeing of the piece of fabric after being flocked.

Likewise, there are flocked fabrics that have their entire surface flocked with designs that have different shapes and colour tones, obtained by the printing of same using the different known printing techniques, after being flocked.

There are also fabrics known that have their surfaces partially flocked, with the flocking having being previously dyed, onto a base fabric that has been previously dyed or even that is not dyed.

Also, and as an alternative to the above, there are partially flocked fabrics onto fabrics that have been previously been printed in different shapes and colours, in which the printed designs are not entirely complemented, accompanied or surrounded with the partially flocked designs made onto said fabrics.

In addition to that which has been stated above, by means of the Spanish patent number P-200102663, the owner of which is the same as the presenter of this present invention, the existence of a machine is known by which it is possible to carry out the calendering, flocking, engraving, drying, thermo-fixing and combing operations in one single processing operation, for the production of printed and flocked fabrics, in the description of which mention is already made of the possibility of obtaining surfaces that are partially printed in several colours and partially flocked, in coloured flocking on the non-printed surfaces, and in so doing allowing the partially flocked surface sections to be accompanied, surrounded or completed by sections of printed fabric, in such a way that the design or drawing required by the manufacturer is achieved. This allows a final decoration of the fabric to be achieved that is made up of a single colour of flocking material in the flocked sections, and a variety of colours to be obtained by the printing of the fabric onto the non-flocked surface sections.

Thus, the applicant has no knowledge of any procedures currently existing that allow for the obtaining of a flocked surface with different colours or tonalities of the flocking material in specific areas of the hair or flocking.

### SUMMARY OF THE INVENTION

This present invention has been proposed with the basic aim of providing a procedure by which it is possible to carry the flocking of surfaces so that the final product has flocked areas with one or more different colours. This objective has been fully achieved by means of the procedure that is going to be the object of the description which follows, and whose main characteristics are included in the part which is characterised in claim number 1.

In essence the procedure put forward by the invention to be described gives a solution to the historical impossibility to obtain flocked surfaces with white flocking, and that at the end of the flocking process the product is coloured in one or more colours, in addition including other additional advantages that will be clear from the description that is given below.

### DESCRIPTION OF A PREFERRED EMBODIMENT

In accordance with the invention, the process for the obtaining of flocked surfaces with white flocking, and by means of this the possibility of colouring this flock with one or more colours in the areas where the flocking material is to be found, to whose surfaces both a layer of adhesive has been applied and the flocking hair/material is made up of the following stages:

a) The applying of one, two or more colours, depending on the design required by the manufacturer, onto the base surface, by means of a printing process, each one of the colours being made up of a special printing paste in which the previously selected colourings have been added.

b) The applying of adhesive to the printed surface from the previous phase, using any known technique;

c) The carrying out of a flocking phase with white or light colour onto the surface as stated by means of electrostatic and/or mechanical means;

d) Drying and thermo-fixing of the flocked surface onto the adhesive material layer; and

e) Sublimation of the flocked surface by means of the application of heat in a manner so that the sublimation effect of the dyeing substances used to provide the colouring of the step a) allows the coloration of the flocking in an ascending direction, from the adhesive layer up to the upper part of the flocking.

The conditions in which the sublimation phase is developed, especially in that which concerns the application of time and temperature will be suitably controlled.

Also, it will be understood that to carry out stage e), it is necessary for the inks used for the application of the colours onto the base surface to have subliminal characteristics, without this meaning that it can be limited to any special type of ink, as the process can be carried out using any type of ink that has the stated characteristic.

In addition, the process put forward by the invention is not limited by any type of material and in so doing allows all or any part of the surface to be flocked. Hence, it can be applied to textiles, paper or any other suitable material.

Thanks to the above stated characteristics, a process is achieved which provides flocked surfaces, in which the flocking material has more than one colour as the process allows for the colouring of the hair/flocking material, with different colours and onto differing zones of same, in accordance with the needs or demands of the manufacturer.

In one form of optimal embodiment, the different stages of the procedure can be carried out in a continuous process, without interruption, when the surface to be printed and flocked is in a partial manner, in which case the use of a single machine of the type described by that already described in the Spanish patent number P-200102663, with which it is possible to carry out all of the operations necessary for the formulation of the flocked surfaces, in addition to reducing the overall process time.

In a less efficient manner, the fabric can be printed in a first phase, and then subsequently go on, in another process, to be flocked on the previously printed surface. This variation of the embodiment, although feasible and also likely to be of practical use, has the disadvantage in comparison to the preferred embodiment of it being impossible to obtain final decorations of the flocked fabric in which the printed design or drawing on the surface of the fabric manages to completely coincide with the shapes of the already partially flocked design.

In an additional variation of an alternative embodiment of the invention, in which an attempt is made to provide an completely flocked surface, the surface of the fabric can be printed by means of any known printing process, but using special subliminal paste for the invention process in order to later deposit the adhesive onto the printed surface using, for example, a toothed scraper, and then carry out the depositing of the hair/flocking material onto the stated surface for thermo-fixing then the adhesive layer and to proceed, in the following stage, with the sublimation of the flocked surface for the colouring of the hair/flocking material.

In accordance with another aspect, the invention has provisioned that the special printing paste can include accelerant components in such a way that the velocity of the sublimation phase can be accelerated.

In accordance with the another additional characteristic of the invention, the above mentioned process allows the possibility of obtaining a flocked fabric which has a surface flocked with white hair/flocking material, in such a way that at the end of the process the flocked material has one, two or more colours.

It is not considered to be necessary to make the content of this description more lengthy in order for an expert in the subject to be able to understand its scope and the advantages to be derived from the invention, likewise to develop and carry the object of same into practice.

However, it must be understood that the invention has been described in accordance with a preferred embodiment of same, by which modifications are likely to be made but without meaning any alteration of the bases of the said invention, both in the process phases or to the machine in which it is put into practice, and equally the materials used for the practical use of the process, so that said materials being subjected to the differing phases described with a view to the obtaining of the results required.

1-4. (canceled)

5. Procedure to obtain flocked surfaces with the flocking material having two or more colours, for application to surfaces flocked with white or pale coloured flocking material aimed especially to provide the flocking material with a colouring in one, two or more colours in specific areas of the flocking material, said surfaces having a layer of adhesive applied for the fixing of the flocking material by thermo-fixing which, is characterised because it includes the following stages:
a) The application of the desired colour, colours or inks to the base surface by using any printing means;
b) The applying of adhesive onto the previously printed colours;
c) The carrying out of the flocking phase with white or light coloured flocking material on the surface chosen, by means of electrostatic and/or mechanical distribution;
d) The carrying out of a drying and thermo-fixing stage of the flocked surface onto the adhesive material layer; and
e) The subjecting the flocked surface to a sublimation phase by means of the application of heat for a time and at a controlled temperature, for the purpose of bringing about the sublimation of the colourings carried out, in an ascending direction from the base layer, the colouring of the flocking to the upper part of the flocking.

6. Procedure in accordance with claim 5 is characterised because the colours or inks are made from a special printing paste in which the desired colouring components, with subliminal characteristics, have previously been incorporated.

7. Procedure in accordance with claim 6 is characterised because the printing paste includes elements which accelerate the sublimation speed.

8. The product obtained by means of the process mentioned in claim 7, essentially consists of a flocked fabric, which is characterised because it includes printed and flocked surface in which the flocking material has one, two or more colours.
